(19) United States
(12) Patent Application Publication
(10) Pub. No.: US 2024/0078106 A1
(43) Pub. Date: Mar. 7, 2024

(54) METHOD AND DEVICE FOR UPDATING SOFTWARE VERSION OF DISTRIBUTED SYSTEM

(71) Applicant: Ruijie Networks Co., Ltd., Fuzhou (Fujian) (CN)

(72) Inventor: Kaiyi WANG, Fuzhou (CN)

(21) Appl. No.: 18/502,213

(22) Filed: Nov. 6, 2023

Related U.S. Application Data
(63) Continuation of application No. PCT/CN2023/073624, filed on Jan. 28, 2023.

(30) Foreign Application Priority Data
Jan. 28, 2022 (CN) 202210108469.1

(51) Int. Cl. G06F 8/65; H04L 41/082

(52) U.S. Cl. CPC G06F 8/65; H04L 41/082

(57) ABSTRACT

This application relates to the field of communications technologies, and in particular, to a method and an apparatus for updating a software version of a distributed system. The method is as follows: A controlling device included in a to-be-updated distributed system receives a download task that is sent by a management server and carries a download path for each update installation package for the to-be-updated distributed system; downloads, from the management server, an update installation package corresponding to each download path carried in the download task; and updates a corresponding to-be-updated device based on each downloaded update installation package. The download task is sent by the management server after the management server determines the to-be-updated distributed system by comparing system-version description information of each of at least two distributed systems connected to the management server with an update installation package set.

### CROSS-REFERENCE TO RELATED APPLICATIONS

The present application is a continuation of International Patent Application No. PCT/CN2023/073624, which claims priority to a Chinese patent application No. 202210108469.1, filed on Jan. 28, 2022, both of which are incorporated herein by reference in their entireties.

### TECHNICAL FIELD

This application relates to the field of communications technologies, and in particular, to a method, device and storage medium for updating a software version of a distributed system.

### BACKGROUND

A management server provides update installation packages required for updating the software version of distributed base stations. The management server typically manages a plurality of distributed base stations in a region or even a city, and the management server is connected to each distributed base station through a public network.

For ease of subsequent maintenance, devices included in distributed base stations managed by the management server are generally deployed as devices with the same or similar types of hardware. In this way, a general version-update installation package may be deployed on the management server, and the version-update installation package includes update installation packages required for updating all distributed base stations managed by the management server. The management server delivers a download task to each managed distributed base station, and after receiving the download task, each distributed base station downloads the general version-update installation package to perform an update.

With rapid development of wireless communications technologies, requirements of actual environments, and constant innovation on devices that constitute a distributed base station, distributed base stations managed by the management server no longer include only devices with the same or similar types of hardware. When still adopting the general version-update installation package a quantity of update installation packages included in the version-update installation package may be significantly greater than a quantity of update installation packages required by some distributed base stations, since the version-update installation package includes all update installation packages that are deployed on the management server and that are required for updating software versions of a plurality of distributed base stations. This results in the problems of an excessively large amount of data of the version-update installation package downloaded by a distributed base station, and excessively large storage space required for the distributed base station to store the version-update installation package.

### SUMMARY

Embodiments of this application are to provide a method and an apparatus for updating a software version of a distributed system, to address a problem in the conventional technology that a version-update installation package downloaded by a distributed base station includes an excessively large amount of data.

Specific technical solutions provided in the embodiments of this application are as follows.

According to a first aspect, a method for updating a distributed system is provided, and is applied to a controlling device included in a to-be-updated distributed system, where the to-be-updated distributed system further includes at least one controlled device, and the method includes:
receiving a download task sent by a management server, where the download task includes a download path for an update installation package for the to-be-updated distributed system, and the download task is obtained based on system-version description information of the to-be-updated distributed system;
downloading, from the management server, a first update installation package corresponding to the download path, where the first update installation package includes an update installation file required by a to-be-updated device in the to-be-updated distributed system; and
updating a corresponding to-be-updated device in the to-be-updated distributed system based on the first update installation package.

In the foregoing method, each update installation package includes all update installation files required by a to-be-updated device in a matching to-be-updated distributed system, and all the update installation files are all update installation files required by and matching the to-be-updated device. Therefore, an update installation package used for a to-be-updated device included in the to-be-updated distributed system does not include other redundant installation files. In addition, for any device that is included in the to-be-updated distributed system and that does not need to be updated, no installation package needs to be downloaded from the management server, and no installation file associated with the device is obtained from a downloaded update installation package either. This can greatly reduce storage space required by the controlling device to store the update installation packages, and can also greatly reduce the amount of data corresponding to each update installation package downloaded by the controlling device included in the to-be-updated distributed system from the management server. In addition, when storage space of the management server is definite, concurrency of downloading update installation packages by the to-be-updated distributed system can also be improved, thereby increasing the download speed and shortening the time consumed by update preparation work before the to-be-updated distributed system is updated.

In some possible embodiments, that the download task is obtained based on system-version description information of the to-be-updated distributed system includes:
determining the to-be-updated distributed system and the download task based on the system-version description information of the to-be-updated distributed system and an update installation package set, where each update installation package in the update installation package set corresponds to a to-be-updated device in a matching distributed system.

In some possible embodiments, before the receiving a download task sent by a management server, the method further includes:
after a system-version-description-information obtaining request sent by the management server is received, obtaining device-version description information of the controlling device and the at least one controlled device, respectively;
combining the obtained device-version description information based on hardware types to obtain the system-version description information of the to-be-updated distributed system; and
sending the system-version description information of the to-be-updated distributed system to the management server.

In the foregoing method, each update installation package included in the update installation package set of the management server also has characteristics of an update installation package corresponding to the download path, and each download path carried in the download task corresponds to a storage path for an update installation package in the update installation package set. In this way, the management server does not need to perform secondary compression and packaging based on system-version description information of at least two distributed systems. This reduces storage space required by the management server to store custom version-update installation packages suitable for a plurality of distributed systems, and also improves flexibility of providing update installation packages, so that types of update installation packages provided for different combinations of to-be-updated distributed systems are fewer, and operation and maintenance is simpler and more convenient. Further, resource consumption of a central processing unit of the management server is reduced, and service life of a disk is extended, so that service performance of the management server can be significantly improved without increasing hardware storage.

In some possible embodiments, before the updating a corresponding to-be-updated device in the to-be-updated distributed system based on the first update installation package, the method further includes:
storing the first update installation package;
adding, according to a download order of update installation packages in the first update installation package, second storage paths for the update installation packages sequentially after a last first storage path in a first path list file stored on the controlling device to obtain a second path list file, where the first path list file includes storage paths for all running installation packages and all rollback installation packages that are stored on the controlling device before downloading is performed based on the download task;
determining a deletable installation package among all installation packages corresponding to the second path list file;
deleting a storage path for each deletable installation package from the second path list file to obtain a third path list file; and
generating latest system-installation-package version information of the to-be-updated distributed system based on the third path list file.

In the foregoing method, the controlling device in the to-be-updated distributed system accurately obtains a deletable installation package based on an update installation package corresponding to the download task, and then deletes a storage path corresponding to the deletable installation package from the second path list file to obtain the third path list file. In this way, all installation packages corresponding to remaining storage paths in the third path list file are to be used. Then, the latest system-installation-package version information of the to-be-updated distributed system may be generated based on the third path list file. In this way, the latest system-installation-package version information including a hardware type matching each installation package for the to-be-updated distributed system is generated based on the stored third path list file that is similar to a directory. An update operation based on the latest system-installation-package version information may quickly complete update work for the to-be-updated device.

In some possible embodiments, the determining a deletable installation package among all installation packages corresponding to the second path list file includes:
obtaining installation packages corresponding to the second path list file;
parsing the installation packages to determine a hardware type matching each of the installation packages;
determining whether each hardware type corresponds to at least three installation packages;
determining that a hardware type corresponding to at least three installation packages is a target hardware type;
obtaining an installation package corresponding to a storage path that is earliest added to the second path list file among storage paths for at least three installation packages corresponding to each target hardware type, to obtain a candidate installation package; and
obtaining a candidate installation package that does not meet a preset condition as the deletable installation package.

In the foregoing method, each installation package further includes a configuration file, and the configuration file describes information included in the installation package, such as an installation file, version information, a hardware type of a matching device, and the like. Therefore, by obtaining and parsing all corresponding installation packages based on the second path list file, installation package information and a matching hardware type for each installation package may be obtained, so as to obtain a deletable installation package. The deletable installation package is an installation package that is not to be used by other hardware types after an update is performed based on the download task and/or by other hardware types after an update is performed based on the download task followed by a system-version rollback operation.

In some possible embodiments, after all downloaded update installation packages are stored, the method further includes:
after the first path list file is obtained, backing up the first path list file; and
after the determining a deletable installation package among all installation packages corresponding to the second path list file, the method further includes:
deleting, from the backup first path list file, a storage path corresponding to each deletable installation package, to obtain a fourth path list file.

In the foregoing method, after the deletable installation packages are determined, the storage path corresponding to each deletable installation package is deleted from the backup first path list file. This can greatly reduce storage space occupied by unnecessary installation packages on the controlling device included in the to-be-updated distributed system.

Further, in this embodiment of this application, the fourth path list file is stored, rather than duplicating and storing an installation package corresponding to the fourth path list file. This can greatly reduce storage space occupied by duplicating and storing an installation package on the controlling device included in the to-be-updated distributed system, and storage space waste caused by storing a corresponding installation-package copy in each device of the to-be-updated distributed system. In this manner of retaining an installation package that may be used and deleting an installation package that is not to be used, storage space occupied by unnecessary installation packages on the controlling device can be released, thereby improving device utilization.

In some possible embodiments, after the obtaining a third path list file, the method further includes:
replacing the first path list file with the third path list file; and
after the obtaining a fourth path list file, the method further includes:
deleting each deletable installation package from an installation package storage space.

In the foregoing method, the deletable installation packages are deleted from the installation package storage space of the controlling device included in the to-be-updated distributed system, so that storage space occupied by unnecessary installation packages on the controlling device can be released, thereby improving device utilization.

In some possible embodiments, the updating a corresponding to-be-updated device in the to-be-updated distributed system based on the first update installation package includes:
determining, based on the latest system-installation-package version information, whether the to-be-updated device matching the first update installation package is the controlling device;
delivering, to a corresponding controlled device, a second update installation package that is in the first update installation package and whose matching to-be-updated device is not the controlling device, so that a controlled device receiving the second update installation package is updated based on the second update installation package; and
performing an update based on a third update installation package that is in the first update installation package and whose matching to-be-updated device is the controlling device.

In the foregoing method, the update operation is generally a reflexive behavior of a device. Therefore, when it is determined, based on the latest system-installation-package version information, that a to-be-updated device is not the controlling device, a corresponding update installation package is delivered to a corresponding controlled device, to complete a software update. Correspondingly, when it is determined that the to-be-updated device is the controlling device, the controlling device updates itself by using the update installation package.

In some possible embodiments, after the determining, based on the latest system-installation-package version information, whether the to-be-updated device matching the first update installation package is the controlling device, the method further includes:
determining whether the to-be-updated device corresponds to at least two update installation packages; and
for a to-be-updated device that corresponds to at least two update installation packages, using, as an update installation package for the corresponding to-be-updated device, an update installation package corresponding to a storage path that is last added to the second path list file among storage paths for the corresponding at least two update installation packages.

In the foregoing method, during a software update based on the latest system-installation-package version information, when it is determined that a to-be-updated device corresponds to a plurality of installation packages, an update installation package that is last added to the second path list file, that is, a latest downloaded update installation package, is used as an update installation package for the to-be-updated device, so that the controlling device included in the to-be-updated distributed system can accurately update a corresponding to-be-updated device.

In some possible embodiments, after the updating a corresponding to-be-updated device in the to-be-updated distributed system based on the downloaded first update installation package, the method further includes:
when it is determined that an update for at least one to-be-updated device is abnormal or at least one device in the to-be-updated distributed system operates abnormally after an update for each to-be-updated device is completed, generating rollback system-installation-package version information of the to-be-updated distributed system based on the fourth path list file; and
performing a system-version rollback operation on the to-be-updated distributed system based on the rollback system-installation-package version information.

In the foregoing method, when an update exception occurs and a system-version rollback operation needs to be performed, rollback system-installation-package version information may be generated based on the obtained fourth path list file, to implement rapid rollback and reduce losses caused by a service abnormality during an update. Further, storing the fourth path list file avoids storage space waste caused by duplicating and storing of installation package copies.

According to a second aspect, a method for updating a distributed system is provided, and is applied to a management server connected to at least two distributed systems, where the at least two distributed systems each include a controlling device and at least one controlled device, and the method includes:
sending a download task to a controlling device included in a to-be-updated distributed system, where a download path for an update installation package for the to-be-updated distributed system, and the download task is obtained based on system-version description information of the to-be-updated distributed system, so that the controlling device downloads a first update installation package corresponding to the download path from the management server, and updates a corresponding to-be-updated device in the to-be-updated distributed system based on the first update installation package.

In some possible embodiments, that the download task is obtained based on system-version description information of the to-be-updated distributed system includes:
determining the to-be-updated distributed system and the download task based on the system-version description information of the to-be-updated distributed system and an update installation package set, where each update installation package in the update installation package set corresponds to a to-be-updated device in a matching distributed system.

In some possible embodiments, the determining the to-be-updated distributed system and the download task based on the system-version description information of the to-be-updated distributed system and an update installation package set includes:
sending a system-version-description-information obtaining request to each of the at least two distributed systems, so that a distributed system receiving the system-version-description-information obtaining request obtains and returns system-version description information of the distributed system;
receiving system-version description information sent by each of the at least two distributed systems;
determining each update installation package for the to-be-updated distributed system;
obtaining a download path for each update installation package; and
generating a download task carrying the download path for each update installation package.

According to a third aspect, an apparatus for updating a distributed system is provided, and is applied to a controlling device included in a to-be-updated distributed system, where the to-be-updated distributed system further includes at least one controlled device, and the apparatus includes:
a receiving module, configured to receive a download task sent by a management server, where the download task includes a download path for an update installation package for the to-be-updated distributed system, and the download task is obtained based on system-version description information of the to-be-updated distributed system;
a download module, configured to download, from the management server, a first update installation package corresponding to the download path, where the first update installation package includes an update installation file required by a to-be-updated device in the to-be-updated distributed system; and
an update module, configured to update a corresponding to-be-updated device in the to-be-updated distributed system based on the first update installation package.

In some possible embodiments, before receiving the download task sent by the management server, the receiving module is further configured to:
after a system-version-description-information obtaining request sent by the management server is received, obtain device-version description information of the controlling device and the at least one controlled device, respectively;
combine the obtained device-version description information based on hardware types to obtain the system-version description information of the to-be-updated distributed system; and
send the system-version description information to the management server.

In some possible embodiments, before updating the corresponding to-be-updated device in the to-be-updated distributed system based on the first update installation package, the update module is further configured to:
store the first update installation package;
add, according to a download order of update installation packages in the first update installation package, second storage paths for the update installation packages sequentially after a last first storage path in a first path list file stored on the controlling device to obtain a second path list file, where the first path list file includes storage paths for all running installation packages and all rollback installation packages that are stored on the controlling device before downloading is performed based on the download task;
determine a deletable installation package among all installation packages corresponding to the second path list file;
delete a storage path for each deletable installation package from the second path list file to obtain a third path list file; and
generate latest system-installation-package version information of the to-be-updated distributed system based on the third path list file.

In some possible embodiments, in the case of determining the deletable installation package among all the installation packages corresponding to the second path list file, the update module is configured to:
obtain installation packages corresponding to the second path list file;
parse the installation packages to determine a hardware type matching each of the installation packages;
determine whether each hardware type corresponds to at least three installation packages;
determine that a hardware type corresponding to at least three installation packages is a target hardware type;
obtain an installation package corresponding to a storage path that is earliest added to the second path list file among storage paths for at least three installation packages corresponding to each target hardware type, to obtain a candidate installation package; and
obtain a candidate installation package that does not meet a preset condition as the deletable installation package.

In some possible embodiments, after all downloaded update installation packages are stored, the update module is further configured to:
after the first path list file is obtained, back up the first path list file; and
after determining the deletable installation package among all the installation packages corresponding to the second path list file, the update module is further configured to:
delete, from the backup first path list file, a storage path corresponding to each deletable installation package, to obtain a fourth path list file.

In some possible embodiments, after obtaining the third path list file, the update module is further configured to:
replace the first path list file with the third path list file; and
after obtaining the fourth path list file, the update module is further configured to:
delete each deletable installation package from an installation package storage space.

In some possible embodiments, in the case of updating the corresponding to-be-updated device in the to-be-updated distributed system based on the first update installation package, the update module is configured to:
determine, based on the latest system-installation-package version information, whether the to-be-updated device matching the first update installation package is the controlling device;
deliver, to a corresponding controlled device, a second update installation package that is in the first update installation package and whose matching to-be-updated device is not the controlling device, so that a controlled device receiving the second update installation package is updated based on the second update installation package; and
perform an update based on a third update installation package that is in the first update installation package and whose matching to-be-updated device is the controlling device.

In some possible embodiments, after determining, based on the latest system-installation-package version information, whether a to-be-updated device matching each update installation package is the controlling device, the update module is further configured to:
determine whether the to-be-updated device corresponds to at least two update installation packages; and
for a to-be-updated device that corresponds to at least two update installation packages, use, as an update installation package for the corresponding to-be-updated device, an update installation package corresponding to a storage path that is last added to the second path list file among storage paths for the corresponding at least two update installation packages.

In some possible embodiments, after updating the corresponding to-be-updated device in the to-be-updated distributed system based the downloaded first update installation package, the update module is further configured to:
when it is determined that an update for at least one to-be-updated device is abnormal or at least one device in the to-be-updated distributed system operates abnormally after an update for each to-be-updated device is completed, generate rollback system-installation-package version information of the to-be-updated distributed system based on the fourth path list file; and
perform a system-version rollback operation on the to-be-updated distributed system based on the rollback system-installation-package version information.

According to a fourth aspect, an apparatus for updating a distributed system is provided, and is applied to a management server connected to at least two distributed systems, where the at least two distributed systems each include a controlling device and at least one controlled device, and the apparatus includes:
a sending module, configured to send a download task to a controlling device included in a to-be-updated distributed system, where the download task is obtained based on system-version description information of the to-be-updated distributed system, so that the controlling device downloads a first update installation package corresponding to the download path from the management server, and updates a corresponding to-be-updated device in the to-be-updated distributed system based on the downloaded first update installation package.

In some possible embodiments, the apparatus further includes:
a first determining module, configured to compare system-version description information of each of the at least two distributed systems with an update installation package set, to determine the to-be-updated distributed system; and
a second determining module, configured to determine a download task that corresponds to the to-be-updated distributed system and that carries a download path for each update installation package for the to-be-updated distributed system, where each update installation package includes all update installation files required by a to-be-updated device in a matching to-be-updated distributed system.

In some possible embodiments, before comparing the system-version description information of each of the at least two distributed systems with the update installation package set, the first determining module is further configured to:
send a system-version-description-information obtaining request to each of the at least two distributed systems, so that a distributed system receiving the system-version-description-information obtaining request obtains and returns system-version description information of the distributed system; and
receive system-version description information sent by each of the at least two distributed systems; and
in the case of determining the download task that corresponds to the to-be-updated distributed system and that carries the download path for each update installation package, the second determining module is configured to:
determine each update installation package for the to-be-updated distributed system;
obtain a download path for each update installation package; and
generate a download task carrying the download path for each update installation package.

According to a fifth aspect, an embodiment of this application provides a network device, where the network device includes a memory and a processor.

The memory is configured to store a computer program or instructions.

The processor is configured to execute the computer program or instructions in the memory, so that the method according to any one of the implementations of the first aspect is performed.

According to a sixth aspect, an embodiment of this application provides a server, where the server includes a processor and a memory.

The memory is configured to store a computer program or instructions.

The processor is configured to execute the computer program or instructions in the memory, so that the method according to any one of the implementations of the second aspect is performed.

According to a seventh aspect, an embodiment of this application provides a computer-readable storage medium, where the computer-readable storage medium stores computer program instructions, and when the computer program instructions are executed by a processor, the steps of the method according to any one of the implementations of the first aspect and the second aspect are implemented.

In addition, for technical effects of any one of the implementations of the second aspect to the seventh aspect, refer to the technical effects of different implementations in the first aspect. Details are not described herein again.

Other features and advantages of this application are described in the following specification, and are partially apparent from the specification or understood through implementation of this application. Objectives and other advantages of this application may be implemented and obtained by a structure particularly specified in the described specification, claims, and accompanying drawings.

### BRIEF DESCRIPTION OF DRAWINGS

The accompanying drawings described herein are intended to provide a further understanding of this application, and form a part of this application. The illustrative embodiments of this application and the description thereof are intended to explain this application and do not unduly limit this application. In the accompanying drawings:

FIG. 1 is a schematic diagram of a system architecture of a system for updating a distributed system according to an embodiment of this application;

FIG. 2 is a schematic diagram of an interaction process of a method for updating a distributed system according to an embodiment of this application;

FIG. 3A and FIG. 3B are schematic diagrams of an application scenario according to an embodiment of this application;

FIG. 4 is a schematic flowchart of generating latest system-installation-package version information according to an embodiment of this application;

FIG. 5 is a schematic flowchart of obtaining a deletable installation package according to an embodiment of this application;

FIG. 6 is a schematic flowchart of a method for updating a distributed system according to an embodiment of this application;

FIG. 7 is a schematic diagram of obtaining a new first path list file and a new fourth path list file by a to-be-updated distributed system according to an embodiment of this application;

FIG. 8 is a schematic diagram of a logical architecture of an apparatus for updating a distributed system according to an embodiment of this application;

FIG. 9 is a schematic diagram of a logical architecture of an apparatus for updating a distributed system according to an embodiment of this application;

FIG. 10 is a schematic diagram of a physical architecture of a network device according to an embodiment of this application; and

FIG. 11 is a schematic diagram of a physical architecture of a server according to an embodiment of this application.

### DESCRIPTION OF EMBODIMENTS

The following clearly and thoroughly describes the technical solutions in the embodiments of this application with reference to the accompanying drawings in the embodiments of this application. Apparently, the described embodiments are merely some but not all of the embodiments of this application. All other embodiments obtained by a person of ordinary skill in the art based on the embodiments of this application without creative efforts shall fall within the protection scope of this application.

It should be noted that, in the specification, claims, and accompanying drawings of this application, the terms “first”, “second”, “third”, and the like are intended to distinguish between similar objects but do not necessarily indicate a specific sequence or order. It should be understood that data used in this way is interchangeable in appropriate circumstances, so that the embodiments of this application described herein can be implemented in orders other than the order illustrated or described herein.

The distributed base station may generally store a version-update installation package corresponding to each download task. In this way, when an update exception occurs during a software version update based on a current download task, or a device operates abnormally after an update, the distributed base station usually needs to perform a base station version rollback operation based on a version-update installation package corresponding to a previous download task adjacent to the current download task. Because the version-update installation package corresponding to each download task includes update installation packages required for updating all distributed base stations managed by the management server, each version-update installation package includes a quite large amount of data. This results in larger storage space required for the distributed base station to store the version-update installation package corresponding to each download task, which seriously affects normal operation of the distributed base station.

In the conventional technology, a management server is configured to provide an update installation package required for updating a software version of a distributed base station. The management server typically manages a plurality of distributed base stations in a region or even a city, and the management server is connected to each distributed base station through a public network.

In the conventional technology, there exists another method for updating and rolling back software of a distributed base station. In practice, after a version-update installation package is deployed on a management server, the management server is first triggered to send an obtaining request to each of a plurality of distributed base stations connected to the management server, where the obtaining request is used for obtaining hardware types and current software version information of different devices in each of the plurality of distributed base stations connected to the management server. After receiving hardware types and current software version information of different devices that are returned by the plurality of distributed base stations, the management server first decompresses the version-update installation package, and then compares received hardware types and current software version information of different devices of each distributed base station with update installation packages obtained through decompression, to customize a custom version-update installation package matching each distributed base station. The management server then stores each custom version-update installation package, determines a download task, and sends the download task to a corresponding distributed base station, so that each distributed base station downloads a corresponding custom version-update installation package from the management server based on a download task of the distributed base station.

However, the foregoing method still has the following problems. The management server typically manages a plurality of distributed base stations in a region or even a city. In this case, when update installation packages used for updating distributed base stations are different, the management server needs to customize a large quantity of custom version-update installation packages in different combinations and store the customized custom version-update installation packages. In this way, although each custom version-update installation package does not include an excessively large amount of data and each custom version-update installation package includes only update installation package used for updating a corresponding distributed base station, the management server has to frequently decompress the version-update installation package based on hardware types and current software version information of different devices of each distributed base station, and compress each update installation package that is used for updating each distributed base station and is obtained through comparison. This not only increases resource consumption of a central processing unit of the management server, but also shortens service life of a disk of the management server.

Further, due to the custom version-update installation packages obtained through customization, storage space required by the management server to store the custom version-update installation packages also increases. When storage space of the management server is definite, bandwidth that a network can support at the same time is definite. Consequently, concurrency of downloading corresponding custom version-update installation packages by distributed base stations is low, download time for downloading a custom version-update installation package during preparation before a distributed base station is updated increases, and so on.

To address the foregoing problems, in the embodiments of this application, a controlling device included in a to-be-updated distributed system receives a download task that is sent by a management server and carries a download path for each update installation package for the to-be-updated distributed system; downloads, from the management server, an update installation package corresponding to each download path carried in the download task; and updates a corresponding to-be-updated device based on each downloaded update installation package. The download task is sent by the management server after the management server determines the to-be-updated distributed system by comparing system-version description information of each of at least two distributed systems connected to the management server with an update installation package set. Each update installation package includes all update installation files required by a to-be-updated device in a matching to-be-updated distributed system. This can greatly reduce storage space required by the controlling device to store the update installation packages, and can also greatly reduce the amount of data corresponding to each update installation package downloaded by the controlling device included in the to-be-updated distributed system from the management server. In addition, when storage space of the management server is definite, concurrency of downloading update installation packages by the to-be-updated distributed system can also be improved, thereby increasing the download speed and shortening the time consumed by update preparation work before the to-be-updated distributed system is updated.

It should be noted that, in the embodiments of this application, each update installation package includes all update installation files required by a to-be-updated device in a matching to-be-updated distributed system, and all the update installation files are all update installation files required by and matching the to-be-updated device. Therefore, an update installation package used by any to-be-updated device included in each to-be-updated distributed system does not include other redundant installation files. In addition, for any device that is included in the to-be-updated distributed system and does not need to be updated, no installation package needs to be downloaded from the management server, and no installation file associated with the device is obtained from a downloaded update installation package either.

Each update installation package included in the update installation package set deployed on the management server also has characteristics of an update installation package corresponding to the download path, and each download path carried in the download task corresponds to a storage path for an update installation package in the update installation package set. In this way, the management server does not need to perform secondary compression and packaging based on system-version description information of at least two distributed systems. This reduces storage space required by the management server to store custom version-update installation packages suitable for a plurality of distributed systems, and also improves flexibility of providing an update installation package, so that types of update installation packages provided for different combinations of distributed systems are fewer, and operation and maintenance is simpler and more convenient. In addition, resource consumption of a central processing unit of the management server is also reduced, and service life of a disk is extended, so that service performance of the management server can be significantly improved without increasing hardware storage.

The following further describes preferred embodiments of this application with reference to the accompanying drawings. It should be understood that the preferred embodiments described herein are merely intended to describe and explain this application, but not to limit this application. In addition, in the case of no conflict, the embodiments of this application and the features in the embodiments may be combined with each other.

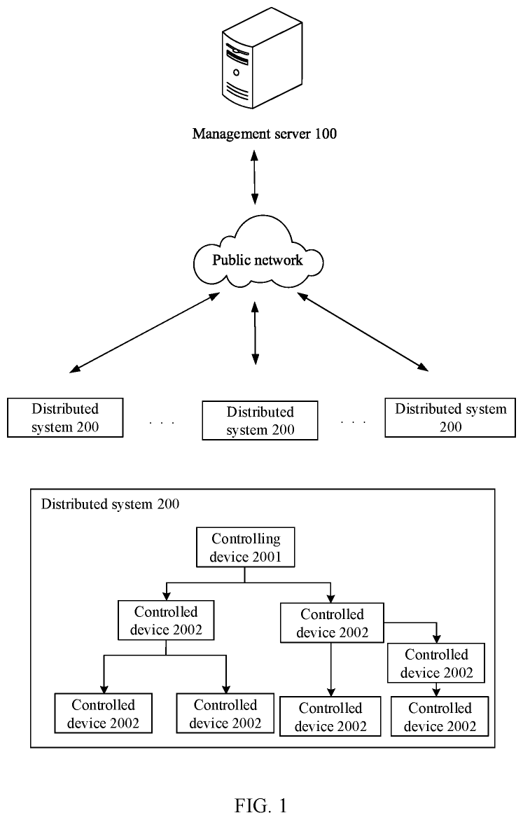

FIG. 1 is a schematic diagram of a system architecture of an update system according to an embodiment of this application. As shown in FIG. 1, the system includes a management server 100 and a distributed system 200 connected to the management server 100. The distributed system 200 is connected to the management server 100 through a public network.

The management server 100 is configured to send a system-version-description-information obtaining request to each of at least two distributed systems 200, and receive system-version description information sent by each of the at least two distributed systems 200; and is further configured to compare the system-version description information of each of the at least two distributed systems 200 with an update installation package set to determine a to-be-updated distributed system, determine a download task that corresponds to the to-be-updated distributed system and carries a download path for each update installation package for the to-be-updated distributed system, and send the download task to a controlling device included in the to-be-updated distributed system.

The distributed system 200 includes a controlling device 2001 and at least one controlled device 2002, and the distributed system 200 interacts with the management server 100 through the controlling device 2001.

During specific implementation, the controlling device 2001 is configured to receive a download task that is sent by the management server 100 and carries a download path for each update installation package for the distributed system 200; and is further configured to download, from the management server 100, an update installation package corresponding to each download path carried in the download task, and update a corresponding to-be-updated device based on each downloaded update installation package. The download task is sent by the management server 100 after the management server 100 determines the to-be-updated distributed system by comparing system-version description information of each of at least two distributed systems 200 connected to the management server 100 with an update installation package set. Each update installation package includes all update installation files required by a to-be-updated device in a matching to-be-updated distributed system.

It should be noted that the distributed system 200 in FIG. 1 is merely a collective term for distributed systems, and is not limited to distributed systems with exactly the same topology. Details are not described again subsequently.

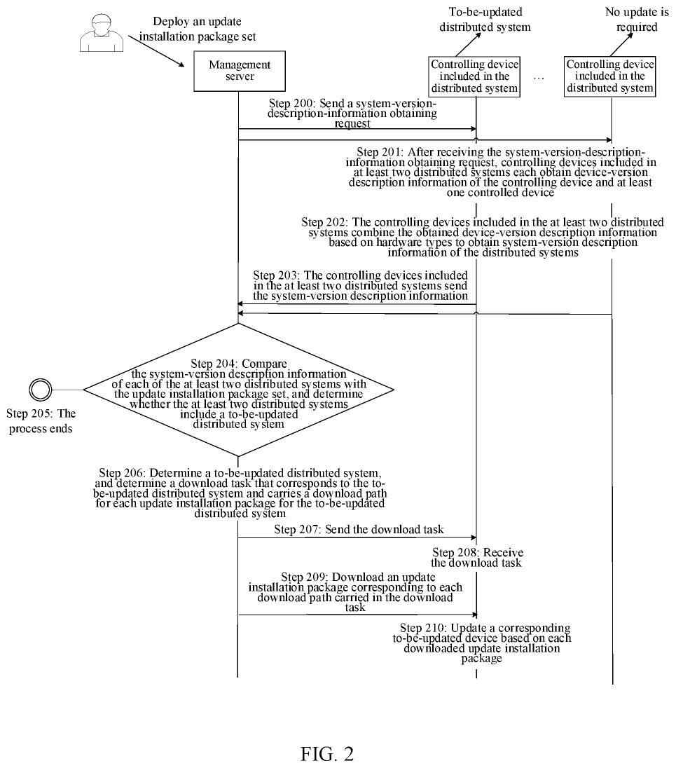

As shown in FIG. 2, an embodiment of this application provides a method for updating a distributed system. A specific process is as follows.

In Step 200, a management server sends a system-version-description-information obtaining request to a controlling device included in each of at least two distributed systems connected to the management server, where the system-version-description-information obtaining request is used to obtain system-version description information of each of the at least two distributed systems.

During specific implementation, a user deploys, on the management server, an update installation package set for updating software of a plurality of managed distributed systems. All update installation files included in each update installation package are all update installation files required by a to-be-updated device matching the corresponding update installation package. Each update installation package further includes a configuration file. The configuration file describes information included in the update installation package, such as an installation file, version information, a hardware type of a matching device, and the like.

Then, after the user deploys the update installation package set on the management server, the management server is triggered to send the system-version-description-information obtaining request to the controlling devices included in the at least two distributed systems connected to the management server, so as to obtain the system-version description information of each of the at least two distributed systems.

It should be noted that, in practice, after the user deploys the update installation package set on the management server, the management server is triggered to send a system-version-description-information obtaining request to the controlling device included in each of the at least two connected distributed systems, and handle, in parallel, interaction processes with the controlling devices included in the at least two distributed systems.

In this embodiment of this application, for ease of description of the method for updating a distributed system, an example in which a controlling device included in one distributed system receives the system-version-description-information obtaining request is used for description. Steps performed by controlling devices included in other distributed systems after reception of the system-version-description-information obtaining request are similar, and details are not described herein again.

In Step 201, after receiving the system-version-description-information obtaining request sent by the management server, the controlling devices included in the at least two distributed systems each obtain device-version description information of the controlling device and at least one controlled device.

During specific implementation, after receiving the system-version-description-information obtaining request sent by the management server, a controlling device included in any one of the at least two distributed systems obtains device-version description information of each device included in the distributed system, that is, obtains a hardware type and current software version information of each device.

In Step 202, the controlling devices included in the at least two distributed systems combine the obtained device-version description information based on hardware types to obtain system-version description information of the distributed systems.

In this embodiment of this application, a controlling device included in any one of the at least two distributed systems combines the obtained device-version description information based on hardware type, that is, combines device-version description information with the same hardware type, to obtain combined device-version description information of the distributed system; and determines the combined device-version description information as system-version description information of the distributed system. The system-version description information includes device-version description information of different devices included in the distributed system, and each piece of device-version description information includes a hardware type and current software version information of a corresponding device.

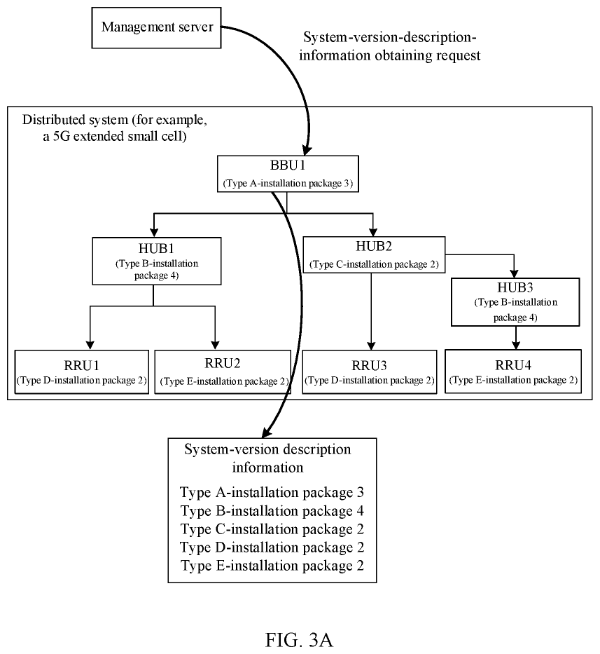

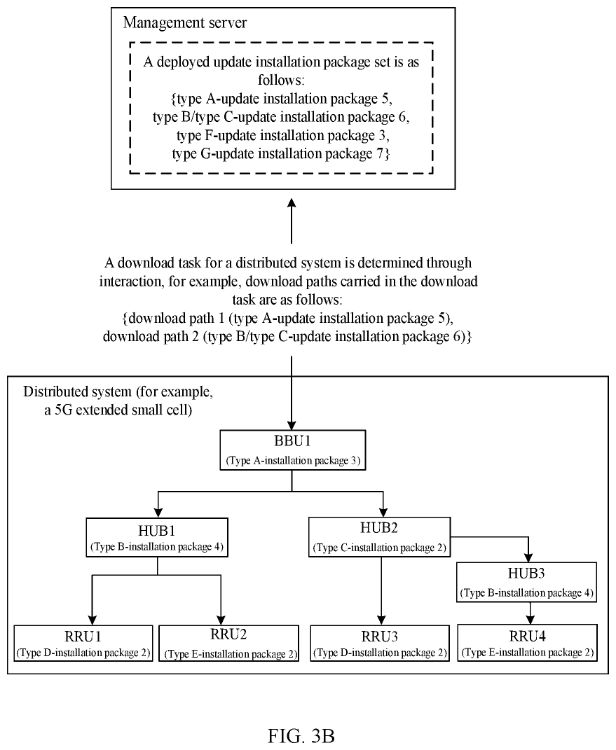

For example, as shown in FIG. 3A, the distributed system is a 5G extended small cell.

As shown in FIG. 3A, the 5G extended small cell includes a baseband processing unit (Baseband Unit, BBU), a switch (HUB), and a remote radio unit (Remote Radio Unit, RRU). The HUB is connected to the BBU and the RRU, and HUBs may alternatively be cascaded. The BBU corresponds to the controlling device in this embodiment of this application, and the HUB and the RRU correspond to the controlled device in this embodiment of this application.

It is assumed that an internal base station topology of the 5G extended small cell is shown in FIG. 3A. To be specific, the 5G extended small cell includes: a BBU, denoted as a BBU1 of a type A; three HUBs, denoted as a HUB1 of a type B, a HUB2 of a type C, and a HUB3 of the type B, where the HUB2 and the HUB3 are cascaded; and four RRUs, denoted as an RRU1 of a type D, an RRU2 of a type E, an RRU3 of the type D, and an RRU4 of the type E, where the RRU1 and the RRU2 are connected to the HUB1, the RRU3 is connected to the HUB2, and the RRU4 is connected to the HUB3.

It is also assumed that a user deploys an update installation package set on the management server, and after the user deploys the update installation package set, the management server is triggered to send a system-version-description-information obtaining request to each of at least two managed 5G extended small cells, where the system-version-description-information obtaining request is used to obtain system-version description information of each of the at least two 5G extended small cells.

In this case, a controlling device included in the 5G extended small cell obtains, based on the system-version-description-information obtaining request, device-version description information of the controlling device and at least one controlled device included in the 5G extended small cell, namely, a hardware type and current software version information of each device.

It is assumed that device-version description information included in one of the at least two 5G extended small cells is shown in the following table:

TABLE 1
Device version description information
of the 5G extended small cell

| | | Device version description information | |
|---|---|---|---|
| | | | Current software version |
| | | Hardware type | information |
| Controlling device | BBU1 | Type A | Installation package 3 |
| Controlled device | HUB1 | Type B | Installation package 4 |
| | HUB2 | Type C | Installation package 2 |
| | HUB3 | Type B | Installation package 4 |
| | RRU1 | Type D | Installation package 2 |
| | RRU2 | Type E | Installation package 2 |
| | RRU3 | Type D | Installation package 2 |
| | RRU4 | Type E | Installation package 2 |

In this case, the controlling device included in the 5G extended small cell combines the obtained device-version description information based on hardware type.

During specific implementation, the device-version description information of the HUB1 and the HUB3 in Table 1 is combined, the device-version description information of the RRU1 and the RRU3 is combined, and the device-version description information of the RRU1 and the RRU3 is combined, to obtain a HUB_{combined} (type B-installation package 4), an RRU_{combined 1} (type D-installation package 2), and an RRU_{combined 2} (type E-installation package 2).

Then combined device-version description information is determined as system-version description information of the 5G extended small cell, as shown in the following table:

TABLE 2
System-version description information
of the 5G extended small cell

| | System-version description information | | |
|---|---|---|---|
| | | Hardware | Current software |
| | | type | version information |
| Controlling device | BBU1 | Type A | Installation package 3 |
| Controlled device | HUB_{combined} | Type B | Installation package 4 |
| | HUB2 | Type C | Installation package 2 |
| | RRU_{combined 1} | Type D | Installation package 2 |
| | RRU_{combined 2} | Type E | Installation package 2 |

It should be noted that, in this embodiment of this application, the current software version information in Table 2 is version information of currently running software of different devices included in a distributed system when the management server obtains system-version description information of the distributed system. For ease of description, an example in which the device-version description information includes a hardware type and software version information of a corresponding device is used for description. In practice, the device-version description information further includes update duration of the corresponding device, and the like. Details are not described again subsequently.

In this embodiment of this application, for ease of description, the software version information is described only by using “installation package+(Arabic numeral)” in Table 2 as an example. In practice, the software version information includes description information that uniquely identifies an update software version and is formed by jointly encapsulating information included in the corresponding installation package, such as an installation package version of a corresponding installation package, a file name of an installation file included in the corresponding installation package, a file version of each included installation file, construction time a construction manufacturer of the corresponding installation package, and the like.

In this embodiment of this application, for ease of description, the hardware type is described only by using “type+(capital letter)” as an example. In practice, the hardware type includes description information that uniquely identifies an update and is obtained by jointly encapsulating a hardware product number, a manufacturer, a product type, and other information.

In Step 203, the controlling devices included in the at least two distributed systems send the system-version description information to the management server.

In this embodiment of this application, during performing Step 203, a controlling device included in any one of the at least two distributed systems sends the system-version description information obtained after Step 202 to the management server, so that the management server compares the system-version description information with the update installation package set to determine whether the distributed system is a to-be-updated distributed system.

In Step 204, the management server compares the system-version description information of each of the at least two distributed systems with the update installation package set, and determines whether the at least two distributed systems include a to-be-updated distributed system. If yes, Step 205 is performed; otherwise, Step 206 is performed.

In this embodiment of this application, after receiving the system-version description information sent by the controlling devices included in the at least two distributed systems, the management server parses each update installation package included in the pre-deployed update installation package set, and compares, based on a parsing result, the update installation package set with version description information of each of the at least two distributed systems to determine whether the at least two distributed systems include a to-be-updated distributed system. If yes, Step 206 is performed; otherwise, Step 205 is performed.

In Step 205, the process ends.

In Step 206, a to-be-updated distributed system is determined, and a download task that corresponds to the to-be-updated distributed system and carries a download path for each update installation package for the to-be-updated distributed system is determined, where each update installation package includes all update installation files required by a to-be-updated device in a matching to-be-updated distributed system.

In this embodiment of this application, when it is determined, based on a comparison result during performing Step 204, that the at least two distributed systems include a to-be-updated distributed system, during performing Step 206, a to-be-updated distributed system is determined, and a download task that corresponds to the to-be-updated distributed system and carries a download path for each update installation package for the to-be-updated distributed system is determined through the following operations, where each update installation package includes all update installation files required by a to-be-updated device in a matching to-be-updated distributed system.
In Operation 1, each update installation package for the to-be-updated distributed system is determined.
In Operation 2, a download path for each update installation package is obtained.
In Operation 3, a download task carrying the download path for each update installation package is generated.

For example, as shown in FIG. 3B, the distributed system is still the 5G extended small cell.

It is assumed that the update installation package set deployed by the user on the management server is {type A-update installation package 5, type B/type C-update installation package 6, type F-update installation package 3, type G-update installation package 7}.

It is also assumed that system-version description information sent by the controlling device included in the 5G extended small cell to the management server is {(type A-installation package 3), (type B-installation package 4), (type C-installation package 2), (type D-installation package 2), (type E-installation package 2)}.

Each update installation package further includes a configuration file, and the configuration file describes information included in the update installation package, such as an installation file, version information, a hardware type of a matching device, and the like. Therefore, after receiving system-version description information of the distributed system, the management server compares the system-version description information with a configuration file of each update installation package included in the update installation package set; and then determines, based on a comparison result, that the 5G extended small cell is a to-be-updated distributed system, and determines a download task carrying a download path for each update installation package. For example, a download path, carried in the download task, for each update installation package for the 5G extended small cell is {download path 1 (type A-update installation package 5), download path 2 (type B/type C-update installation package 6)}.

It should be noted that any download path carried in the download task determined by the management server corresponds to a storage path for an update installation package in the update installation package set. In this case, the management server only needs to store each update installation package, instead of determining each update installation package suitable for the distributed system based on system-version description information of each distributed system and then further compressing and packaging each determined update installation package as in the conventional technology. Therefore, in this solution, a storage capacity used by the management server to store custom version-update installation packages suitable for a plurality of distributed systems is reduced, and operation and maintenance complexity is also reduced.

In Step 207, the management server sends the download task to a controlling device included in the to-be-updated distributed system.

In this embodiment of this application, during performing Step 207, the download task determined after Step 206 is sent to the controlling device included in the to-be-updated distributed system. Therefore, the controlling device included in the to-be-updated distributed system downloads, from the management server, an update installation package corresponding to a download path, carried in the download task, for each update installation package, and updates a corresponding to-be-updated device based on each downloaded update installation package.

In Step 208, the controlling device included in the to-be-updated distributed system receives the download task that is sent by the management server and carries a download path for each update installation package for the to-be-updated distributed system.

In Step 209, an update installation package corresponding to each download path carried in the download task is downloaded from the management server.

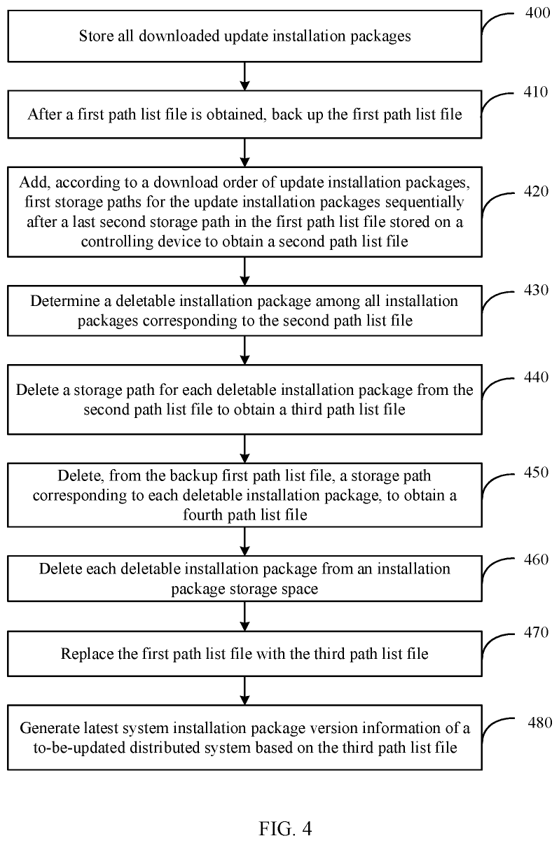

In this embodiment of this application, during performing Step 209, the controlling device included in the to-be-updated distributed system downloads, from the management server based on each download path carried in the download task, an update installation package corresponding to each download path. Then, as shown in FIG. 4, after Step 209 is performed and before Step 210 is performed, the following steps are further specifically performed.

In Step 400, all downloaded update installation packages are stored.

In this embodiment of this application, during performing Step 400, downloaded update installation packages are sequentially stored in an installation package storage space according to a download order, to obtain a first storage path corresponding to each update installation package, where each first storage path is used to uniquely record a storage path for the update installation package on the controlling device included in the to-be-updated distributed system.

In Step 410, after a first path list file is obtained, the first path list file is backed up.

In this embodiment of this application, after Step 400 is performed, the first path list file is obtained, and the first path list file is backed up. The first path list file includes storage paths for all running installation packages and all rollback installation packages that are stored on the controlling device included in the to-be-updated distributed system before downloading is performed based on the download task. The backup first path list file is used to construct a fourth path list file of the to-be-updated distributed system. The fourth path list file is used to generate rollback system-installation-package version information. The rollback system-installation-package version information is used when a system-version rollback operation needs to be performed on the to-be-updated distributed system.

In Step 420, first storage paths for the update installation packages are added, according to a download order of update installation packages, sequentially after a last second storage path in the first path list file stored on the controlling device to obtain a second path list file.

In Step 430, a deletable installation package is determined among all installation packages corresponding to the second path list file.

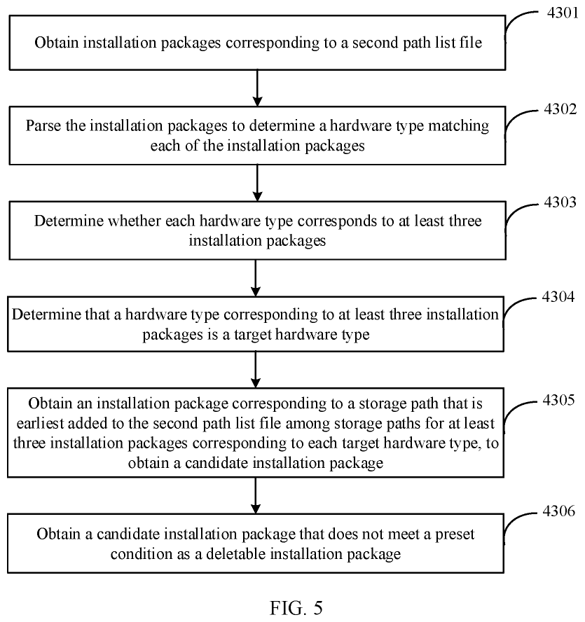

In this embodiment of this application, as shown in FIG. 5, during performing Step 430, the deletable installation package is determined through the following steps.

In Step 4301, installation packages corresponding to the second path list file are obtained.

In this embodiment of this application, during performing Step 4301, the controlling device included in the to-be-updated distributed system may obtain all installation packages from the installation package storage space at a time based on all storage paths included in the second path list file; or may obtain a corresponding installation package from the installation package storage space one by one according to a sorting order of storage paths included in the second path list file, that is, an order from an earliest added (earliest downloaded) installation package to a last added (last downloaded) installation package.

In Step 4302, the installation packages are parsed to determine a hardware type matching each of the installation packages.

In this embodiment of this application, when the controlling device included in the to-be-updated distributed system obtains all installation packages from the installation package storage space at a time during performing Step 4301, during performing Step 4302, the controlling device included in the to-be-updated distributed system sequentially parses the installation packages according to the sorting order of the storage paths in the second path list file, that is, the order from the earliest added (earliest downloaded) installation package to the last added (last downloaded) installation package, to determine a hardware type matching each installation package.

When the controlling device included in the to-be-updated distributed system obtains an installation package from the installation package storage space one by one according to the order from the earliest added (earliest downloaded) installation package to the last added (last downloaded) installation package during performing Step 4301, during performing Step 4302, the controlling device included in the to-be-updated distributed system parses the obtained installation package to determine a hardware type matching the installation package, until an update installation package corresponding to the last first storage path is parsed to determine a hardware type matching the update installation package.

In Step 4303, whether each hardware type corresponds to at least three installation packages is determined.

In this embodiment of this application, the controlling device included in the to-be-updated distributed system determines, from a determined hardware type that matches each installation package, whether each hardware type corresponds to at least three installation packages.

In Step 4304, it is determined that a hardware type corresponding to at least three installation packages is a target hardware type.

In this embodiment of this application, during performing Step 4304, a hardware type that corresponds to at least three installation packages and is determined in Step 4303 is determined as the target hardware type.

In Step 4305, an installation package corresponding to a storage path that is earliest added to the second path list file among storage paths for at least three installation packages corresponding to each target hardware type is obtained, to obtain a candidate installation package.

In this embodiment of this application, during performing Step 4305, an installation package corresponding to a storage path that is earliest added to the second path list file among storage paths for at least three installation packages corresponding to each target hardware type indicates that the installation package is first downloaded by the controlling device from the management server. It should be noted that the being first downloaded is not being first downloaded in a current download task, but indicates that the installation package is first downloaded among all installation packages corresponding to all storage paths included in the second path list file.

In Step 4306, a candidate installation package that does not meet a preset condition is obtained as the deletable installation package.

In this embodiment of this application, after each candidate installation package is obtained in Step 4305, during performing Step 4306, whether each candidate installation package meets a preset condition needs to be determined, where the preset condition includes but is not limited to the following conditions.
Condition 1: The candidate installation package is to be used by other hardware types after an update is performed based on the download task.
Condition 2: The candidate installation package is to be used by other hardware types after an update is performed based on the download task followed by a system-version rollback operation.

When it is determined that the candidate installation package does not meet the preset condition, the candidate installation package is determined as a deletable installation package.

It should be noted that the deletable installation package may or may not exist. During specific implementation, specific determining is performed based on an actual case. In this embodiment of this application, only one manner of determining a deletable installation package is provided, but the determining manner does not constitute a limitation. Details are not described herein again.

For example, the to-be-updated distributed system as a 5G extended small cell.

It is assumed that four installation packages have been stored in an installation package storage space of a controlling device included in the 5G extended small cell before the download task is performed, and the four installation packages are an installation package 1 (a second storage path 1), an installation package 2 (a second storage path 2), an installation package 3 (a second storage path 3), and an installation package 4 (a second storage path 4).

In this case, after downloading, from the management server, an update installation package corresponding to each download path carried in the download task, the controlling device included in the 5G extended small cell stores all update installation packages to obtain a storage path corresponding to each update installation package. For example, a storage path corresponding to an update installation package 5 is a first storage path 1, and a storage path corresponding to an update installation package 6 is a first storage path 2.

Then the controlling device included in the 5G extended small cell obtains a first path list file and backs up the first path list file; and then adds, according to a download order of update installation packages, first storage paths for the update installation packages sequentially after a last second storage path in the first path list file to obtain a second path list file.

Table 3 shows the first path list file and the second path list file obtained by the controlling device included in the 5G extended small cell.

TABLE 3
First path list file and second path list file

| Obtained first path list file | Obtained second path list file |
|---|---|
| Second storage path 1 | Second storage path 1 |
| (installation package 1) | (installation package 1) |
| Second storage path 2 | Second storage path 2 |
| (installation package 2) | (installation package 2) |
| Second storage path 3 | Second storage path 3 |
| (installation package 3) | (installation package 3) |
| Second storage path 4 | Second storage path 4 |
| (installation package 4) | (installation package 4) |
| | First storage path 1 (update |
| | installation package 5) |
| | First storage path 2 (update |
| | installation package 6) |

Then the controlling device included in the 5G extended small cell determines a deletable installation package among all installation packages corresponding to the second path list file.

During specific implementation, the controlling device obtains each installation package corresponding to the second path list file, parses each installation package, and determines a hardware type matching each installation package.

It is assumed that hardware types matching installation packages are shown in the following table:

TABLE 4
List of hardware types matching installation packages
determined based on the second path list file

| | | | | | Update | Update |
|---|---|---|---|---|---|---|
| | Installation | Installation | Installation | Installation | installation | installation |
| | package 1 | package 2 | package 3 | package 4 | package 5 | package 6 |
| Type A | Y | | Y | | Y | |
| Type B | Y | | | Y | | Y |
| Type C | | Y | | | | Y |
| Type D | | Y | | | | |
| Type E | | Y | | | | |

Note:
“Y” in Table 4 indicates that the installation package is suitable for the hardware type.

It should be noted that, for ease of description, Table 4 lists only hardware types matching all installation packages in the second path list file. In practice, the foregoing table further includes hardware types matching installation package information of installation packages, where each piece of installation package information includes a storage path for a corresponding installation package on the controlling device, version information of the corresponding installation package, decompression path information of each installation file included in the corresponding installation package, and sorting information, in the second path list file, of the storage path for the corresponding installation package.

Then the controlling device included in the 5G extended small cell determines, based on Table 4, whether each hardware type corresponds to at least three installation packages, and determines that a hardware type corresponding to at least three installation packages is a target hardware type. For example, the target hardware type is the type A and the type B.

After determining the target hardware type, the controlling device included in the 5G extended small cell obtains an installation package corresponding to a storage path that is earliest added to the second path list file among storage paths for at least three installation packages corresponding to each target hardware type, to obtain a candidate installation package.

During specific implementation, in a case that the target hardware type is the type A, the controlling device included in the 5G extended small cell obtains, from storage paths for at least three installation packages corresponding to the type A, an installation package corresponding to a storage path that is earliest added to the second path list file. To be specific, an installation package that corresponds to the storage path earliest added to the second path list file and is obtained from the installation package 1, the installation package 3, and the update installation package 5 is the installation package 1. In this case, an obtained candidate installation package is the installation package 1.

Correspondingly, in a case that the target hardware type is the type B, the controlling device included in the 5G extended small cell obtains, from storage paths for at least three installation packages corresponding to the type B, an installation package corresponding to a storage path that is earliest added to the second path list file, to obtain a candidate installation package. To be specific, an installation package that corresponds to the storage path earliest added to the second path list file and is obtained from the installation package 1, the installation package 4, and the update installation package 6 is the installation package 1. In this case, an obtained candidate installation package is also the installation package 1.

Then the controlling device included in the 5G extended small cell obtains a candidate installation package that does not meet a preset condition as a deletable installation package.

During specific implementation, based on each candidate installation package, the controlling device included in the 5G extended small cell determines whether each candidate installation package is suitable for use by other hardware types after the 5G extended small cell is updated based on the download task, and determines whether each candidate installation package is suitable for use by other hardware types after the 5G extended small cell is updated based on the download task followed by a system-version rollback operation.

During an update of a distributed system based on the download task, an update installation package corresponding to each download path carried in the download task needs to be used. Therefore, a deletable installation package is not an update installation package corresponding to the download task, that is, a deletable installation package is definitely among installation packages stored on the 5G extended small cell before the download task is performed.

During specific implementation, the following installation packages are to be used on the 5G extended small cell: type A-update installation package 5 (after an update)-installation package 3 (after a rollback), type B-update installation package 6 (after an update)-installation package 4 (after a rollback), type C-update installation package 6 (after an update)-installation package 2 (after a rollback), type D-installation package 2 (after an update)-installation package 2 (after a rollback), and type E-installation package 2 (after an update)-installation package 2 (after a rollback).

In this case, when the controlling device included in the 5G extended small cell determines that the candidate installation package (namely, the installation package 1) is not to be used by other hardware types after an update is performed based on the download task followed by a system-version rollback operation, the controlling device included in the 5G extended small cell determines that the candidate installation package (namely, the installation package 1) is a deletable installation package, that is, the candidate installation package (namely, the installation package 1) is an unnecessary installation package and therefore can be deleted.

It is assumed that hardware types matching installation packages are shown in the following table:

TABLE 5
List of hardware types matching installation packages
determined based on the second path list file

| | | | | | Update | Update |
|---|---|---|---|---|---|---|
| | Installation | Installation | Installation | Installation | installation | installation |
| | package 1 | package 2 | package 3 | package 4 | package 5 | package 6 |
| Type A | Y | | Y | | Y | |
| Type B | Y | | | Y | | Y |
| Type C | | Y | | | | Y |
| Type D | | Y | | | | |
| Type E | | Y | | | | |
| Type H | Y | | | | | |

Note:
“Y” in Table 5 indicates that the installation package is suitable for the hardware type.

It should be noted that, for ease of description, Table 5 lists only hardware types matching all installation packages in the second path list file. In practice, the foregoing table further includes hardware types matching installation package information of installation packages, where each piece of installation package information includes a storage path for a corresponding installation package on the controlling device, version information of the corresponding installation package, decompression path information of each installation file included in the corresponding installation package, and sorting information, in the second path list file, of the storage path for the corresponding installation package.

In this case, a target hardware type determined by the controlling device included in the 5G extended small cell based on Table 5 is still the type A and the type B, and a candidate installation package obtained by obtaining, based on the type A and the type B, an installation package corresponding to a storage path that is earliest added to the second path list file among storage paths for at least three installation packages corresponding to each target hardware type is still the installation package 1.

However, when the controlling device included in the 5G extended small cell obtains a candidate installation package that does not meet a preset condition as a deletable installation package, the controlling device included in the 5G extended small cell determines that the installation package 1 is to be used by the type H after an update is performed based on the download task and a system-version rollback operation needs to be performed. In this case, the controlling device included in the 5G extended small cell cannot obtain a deletable installation package, that is, there is no unnecessary installation package in this application scenario.

In Step 440, a storage path for each deletable installation package is deleted from the second path list file to obtain a third path list file.

In this embodiment of this application, after a deletable installation package is determined in Step 430, during performing Step 440, a storage path corresponding to each deletable installation package is deleted from the second path list file to obtain the third path list file, where the third path list file is used to generate latest system-installation-package version information of the distributed system, to be used for an update based on the download task.

In Step 450, a storage path corresponding to each deletable installation package is deleted from the backup first path list file, to obtain a fourth path list file.

In this embodiment of this application, after a deletable installation package is determined, Step 450 is performed to delete a storage path corresponding to each deletable installation package from the backup first path list file, so as to obtain the fourth path list file. The fourth path list file includes second storage paths corresponding to all running installation packages required for running of the distributed system before the controlling device performs downloading based on the download task. The fourth path list file is used to generate rollback system-installation-package version information of the to-be-updated distributed system. The rollback system-installation-package version information is used as follows: When the to-be-updated distributed system determines that an update for at least one to-be-updated device is abnormal or at least one device in the to-be-updated distributed system operates abnormally after an update for each to-be-updated device is completed, the to-be-updated distributed system performs a system-version rollback operation based on the rollback system-installation-package version information.

It should be noted that an order of performing Step 440 and Step 450 is not limited in this embodiment of this application, and Step 440 may be performed first, Step 450 may be performed first, or Step 440 and Step 450 may be performed simultaneously.

In Step 460, each deletable installation package is deleted from the installation package storage space.

In this embodiment of this application, after Step 440 and Step 450 are performed, each determined deletable installation package is deleted from the installation package storage space. In this way, an unnecessary installation package is cleared in a timely manner, so that memory space required by the controlling device included in the distributed system to store installation packages can be reduced.

In Step 470, the first path list file is replaced with the third path list file.

In Step 480, latest system-installation-package version information of the to-be-updated distributed system is generated based on the third path list file.

In this embodiment of this application, during performing Step 480, the controlling device included in the to-be-updated distributed system generates the latest system-installation-package version information of the to-be-updated distributed system based on the third path list file. The latest system-installation-package version information is constructed jointly based on configuration files included in all installation packages corresponding to the third path list file, and includes each pieces of installation package information and a matching hardware type. Each piece of installation package information includes a storage path for a corresponding installation package on the controlling device, version information of the corresponding installation package, decompression path information of each installation file included in the corresponding installation package, and sorting information, in the third path list file, of the storage path for the corresponding installation package.

In Step 210, a corresponding to-be-updated device is updated based on each downloaded update installation package.

In this embodiment of this application, during performing Step 210, a to-be-updated device is updated based on the latest system-installation-package version information generated in Step 480 and each downloaded update installation package.

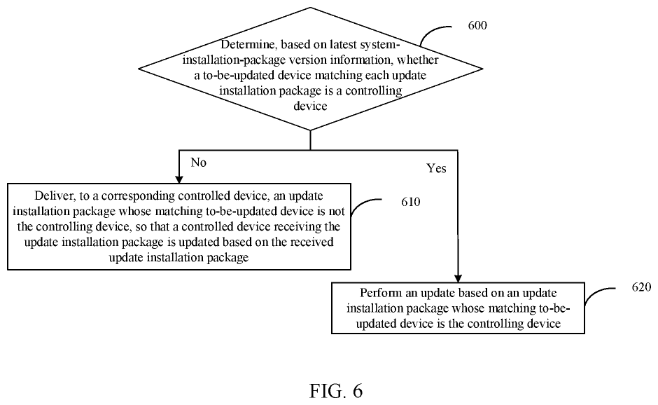

During specific implementation, as shown in FIG. 6, during performing Step 210, the foregoing functions are implemented through the following steps.

In Step 600, whether a to-be-updated device matching each update installation package is the controlling device is determined based on the latest system-installation-package version information. If yes, Step 620 is performed; otherwise, Step 610 is performed.

In this embodiment of this application, after Step 600 is performed, an update installation package for a to-be-updated device is further determined through the following operations.
In Operation 1, whether each to-be-updated device corresponds to at least two update installation packages is determined.
In Operation 2, for a to-be-updated device that corresponds to at least two update installation packages, an update installation package corresponding to a storage path that is last added to the second path list file among storage paths for the corresponding at least two update installation packages is used as an update installation package for the corresponding to-be-updated device.

In Step 610, an update installation package whose matching to-be-updated device is not the controlling device is delivered to a corresponding controlled device, so that a controlled device receiving the update installation package is updated based on the received update installation package.

In this embodiment of this application, the controlling device included in the to-be-updated distributed system determines that a to-be-updated device matching each update installation package is not the controlling device, and then delivers, to a corresponding controlled device, an update installation package whose matching to-be-updated device is not the controlling device, so that the controlled device updates a software version of the controlled device.

In Step 620, an update is performed based on an update installation package whose matching to-be-updated device is the controlling device.

In this embodiment of this application, the controlling device included in the to-be-updated distributed system determines that a to-be-updated device matching each update installation package is the controlling device, and updates software of the controlling device based on the update installation package.

In this embodiment of this application, after Step 210 is performed, when the controlling device included in the to-be-updated distributed system determines that an update for at least one to-be-updated device is abnormal or at least one device in the to-be-updated distributed system operates abnormally after an update for each to-be-updated device is completed, the controlling device included in the to-be-updated distributed system generates rollback system-installation-package version information of the to-be-updated distributed system based on the fourth path list file, and then performs a system-version rollback operation on the to-be-updated distributed system based on the rollback system-installation-package version information.

It should be noted that the following two special cases exist in this embodiment of this application.
Special case 1: When the controlling device included in the to-be-updated distributed system determines that all update installation packages corresponding to all download paths carried in the download task match all hardware types included in the to-be-updated distributed system, the download task corresponds to a whole-station version-update download task of the to-be-updated distributed system.
Special case 2: When the controlling device included in the to-be-updated distributed system determines that all update installation packages corresponding to all download paths carried in the download task match only some hardware types included in the to-be-updated distributed system, the download task corresponds to an incremental version-update download task of the to-be-updated distributed system.

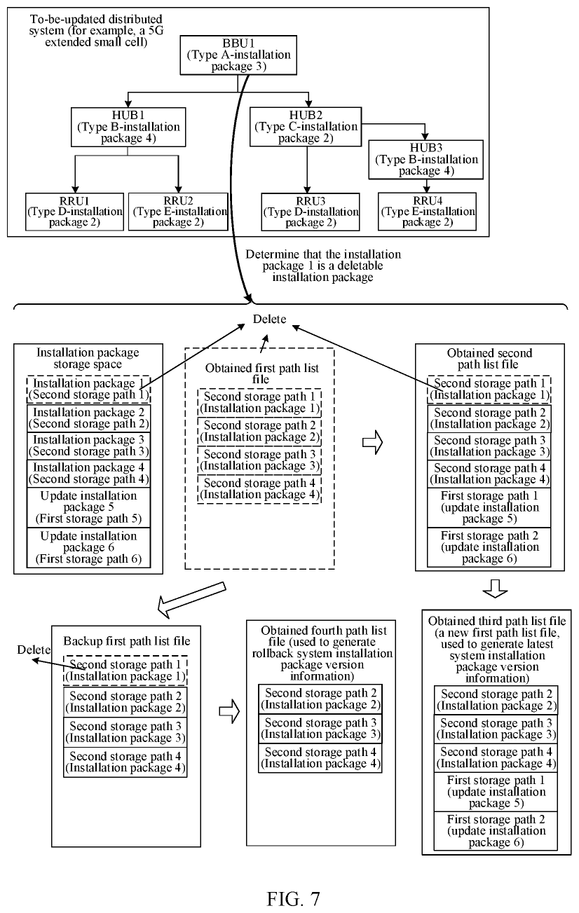

For example, as shown in FIG. 7, the to-be-updated distributed system is still the 5G extended small cell.

It is assumed that a deletable installation package determined by the controlling device included in the 5G extended small cell is the installation package 1.

In this case, the controlling device included in the 5G extended small cell deletes a second storage path corresponding to the installation package 1 from the second path list file to obtain a third path list file, and replaces the first path list file with the third path list file. In this embodiment of this application, the obtained third path list file (namely, a new first path list file) is shown in Table 6:

TABLE 6
Third path list file (namely, the new first path list file)
Third path list file (new first path list file)

Second storage path 2 (installation package 2)
Second storage path 3 (installation package 3)
Second storage path 4 (installation package 4)
First storage path 1 (update installation package 5)
First storage path 2 (update installation package 6)

Then the second storage path corresponding to the installation package 1 is deleted from the backup first path list file to obtain a fourth path list file. In this embodiment of this application, the obtained fourth path list file is shown in Table 7:

TABLE 7
Fourth path list file
Fourth path list file

Second storage path 2 (installation package 2)
Second storage path 3 (installation package 3)
Second storage path 4 (installation package 4)

Then the installation package 1 is deleted from the installation package storage space to release storage space. In this case, a list of installation packages stored in the installation package storage space is shown in Table 8:

TABLE 8
Comparison between installation packages stored
in the installation package storage space

| Installation package storage space | Installation package storage space |
|---|---|
| (before a deletable installation | (after a deletable installation |
| package is deleted) | package is deleted) |
| Installation package 1 | Installation package 2 |
| (second storage path 1) | (second storage path 2) |
| Installation package 2 | Installation package 3 |
| (second storage path 2) | (second storage path 3) |
| Installation package 3 | Installation package 4 |
| (second storage path 3) | (second storage path 4) |
| Installation package 4 | Update installation package 5 |
| (second storage path 4) | (first storage path 1) |
| Update installation package 5 | Update installation package 6 |
| (first storage path 1) | (first storage path 2) |
| Update installation package 6 | |
| (first storage path 2) | |

When the controlling device determines that an update for at least one to-be-updated device is abnormal or at least one device in the to-be-updated distributed system operates abnormally after an update for each to-be-updated device is completed, for example, the controlling device (namely, the BBU1 of the type A) included in the 5G extended small cell determines that an update for a device (for example, the HUB2 of the type C) is abnormal or a device (for example, the BBU1) included in an updated distributed system operates abnormally, the controlling device generates system rollback installation package version information based on the fourth path list file, and performs a system-version rollback operation on the 5G extended small cell based on the system rollback installation package version information.

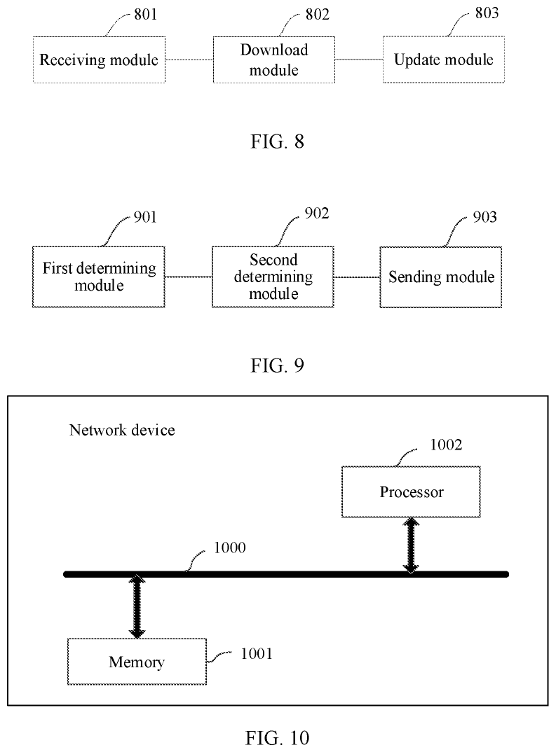

Based on the same inventive concept, as shown in FIG. 8, an embodiment of this application provides an apparatus for updating a distributed system. The apparatus is applied to a controlling device included in a to-be-updated distributed system, where the to-be-updated distributed system further includes at least one controlled device, and the apparatus includes:
a receiving module 801, configured to receive a download task that is sent by a management server and carries a download path for each update installation package for the to-be-updated distributed system, where the download task is sent by the management server after the management server determines the to-be-updated distributed system by comparing system-version description information of each of at least two distributed systems connected to the management server with an update installation package set, and each update installation package includes all update installation files required by a to-be-updated device in a matching to-be-updated distributed system;
a download module 802, configured to download, from the management server, an update installation package corresponding to each download path carried in the download task; and
an update module 803, configured to update a corresponding to-be-updated device based on each downloaded update installation package.

In some possible embodiments, before receiving the download task that is sent by the management server and carries the download path for each update installation package for the to-be-updated distributed system, the receiving module 801 is further configured to:
after a system-version-description-information obtaining request sent by the management server is received, obtain device-version description information of the controlling device and the at least one controlled device, respectively;
combine the obtained device-version description information based on hardware types to obtain the system-version description information of the to-be-updated distributed system; and
send the system-version description information to the management server.

In some possible embodiments, before updating a corresponding to-be-updated device based on each downloaded update installation package, the update module 803 is further configured to:
store all downloaded update installation packages;
add, according to a download order of update installation packages, first storage paths for the update installation packages sequentially after a last second storage path in a first path list file stored on the controlling device to obtain a second path list file, where the first path list file includes storage paths for all running installation packages and all rollback installation packages that are stored on the controlling device before downloading is performed based on the download task;
determine a deletable installation package among all installation packages corresponding to the second path list file;
delete a storage path for each deletable installation package from the second path list file to obtain a third path list file; and
generate latest system-installation-package version information of the to-be-updated distributed system based on the third path list file.

In some possible embodiments, in the case of determining the deletable installation package among all the installation packages corresponding to the second path list file, the update module 803 is configured to:
obtain installation packages corresponding to the second path list file;
parse the installation packages to determine a hardware type matching each of the installation packages;
determine whether each hardware type corresponds to at least three installation packages;
determine that a hardware type corresponding to at least three installation packages is a target hardware type;
obtain an installation package corresponding to a storage path that is earliest added to the second path list file among storage paths for at least three installation packages corresponding to each target hardware type, to obtain a candidate installation package; and
obtain a candidate installation package that does not meet a preset condition as the deletable installation package.

In some possible embodiments, after all downloaded update installation packages are stored, the update module 803 is further configured to:
after the first path list file is obtained, back up the first path list file; and
after determining the deletable installation package among all the installation packages corresponding to the second path list file, the update module 803 is further configured to:
delete, from the backup first path list file, a storage path corresponding to each deletable installation package, to obtain a fourth path list file.

In some possible embodiments, after obtaining the third path list file, the update module 803 is further configured to:
replace the first path list file with the third path list file; and
after obtaining the fourth path list file, the update module 803 is further configured to:
delete each deletable installation package from an installation package storage space.

In some possible embodiments, in the case of updating a corresponding to-be-updated device based on each downloaded update installation package, the update module 803 is configured to:
determine, based on the latest system-installation-package version information, whether a to-be-updated device matching each update installation package is the controlling device;
deliver, to a corresponding controlled device, an update installation package whose matching to-be-updated device is not the controlling device, so that a controlled device receiving the update installation package is updated based on the received update installation package; and
perform an update based on an update installation package whose matching to-be-updated device is the controlling device.

In some possible embodiments, after determining, based on the latest system-installation-package version information, whether a to-be-updated device matching each update installation package is the controlling device, the update module 803 is further configured to:
determine whether each to-be-updated device corresponds to at least two update installation packages; and
for a to-be-updated device that corresponds to at least two update installation packages, use, as an update installation package for the corresponding to-be-updated device, an update installation package corresponding to a storage path that is last added to the second path list file among storage paths for the corresponding at least two update installation packages.

In some possible embodiments, after updating a corresponding to-be-updated device based on each downloaded update installation package, the update module 803 is further configured to:
when it is determined that an update for at least one to-be-updated device is abnormal or at least one device in the to-be-updated distributed system operates abnormally after an update for each to-be-updated device is completed, generate rollback system-installation-package version information of the to-be-updated distributed system based on the fourth path list file; and
perform a system-version rollback operation on the to-be-updated distributed system based on the rollback system-installation-package version information.

Based on the same inventive concept, as shown in FIG. 9, an embodiment of this application provides an apparatus for updating a distributed system. The apparatus is applied to a management server connected to at least two distributed systems, where the at least two distributed systems each include a controlling device and at least one controlled device, and the apparatus includes:
a first determining module 901, configured to compare system-version description information of each of at least two distributed systems with an update installation package set, to determine the to-be-updated distributed system;
a second determining module 902, configured to determine a download task that corresponds to the to-be-updated distributed system and carries a download path for each update installation package for the to-be-updated distributed system, where each update installation package includes all update installation files required by a to-be-updated device in a matching to-be-updated distributed system; and
a sending module 903, configured to send the download task to the controlling device included in the to-be-updated distributed system, so that the controlling device downloads, from the management server, an update installation package corresponding to a download path, carried in the download task, for each update installation package, and updates a corresponding to-be-updated device based on each downloaded update installation package.

In some possible embodiments, before comparing the system-version description information of each of the at least two distributed systems with the update installation package set, the first determining module 901 is further configured to:
send a system-version-description-information obtaining request to each of the at least two distributed systems, so that a distributed system receiving the system-version-description-information obtaining request obtains and returns system-version description information of the distributed system;
receive system-version description information sent by each of the at least two distributed systems; and
in the case of determining the download task that corresponds to the to-be-updated distributed system and carries the download path for each update installation package, the second determining module 902 is configured to:
determine each update installation package for the to-be-updated distributed system;
obtain a download path for each update installation package; and
generate a download task carrying the download path for each update installation package.

As shown in FIG. 10, an embodiment of this application provides a network device, including a memory 1001 and a processor 1002. Details are as follows.

The memory 1001 is configured to store a computer program or instructions.

The processor 1002 is configured to execute the computer program or instructions in the memory, to implement any one of the methods performed by the apparatus for updating a distributed system (for example, a controlling device in the distributed system) in the foregoing embodiments.

A specific connection medium between the memory 1001 and the processor 1002 is not limited in this embodiment of this application. In this embodiment of this application, in FIG. 10, the memory 1001 and the processor 1002 are connected through a bus 1000. The bus 1000 is represented by a bold line in FIG. 10. A connection manner between other components is described merely as an example and does not constitute a limitation. The bus 1000 may be categorized as an address bus, a data bus, a control bus, or the like. For ease of representation, only one bold line is used to represent the bus in FIG. 10, but this does not mean that there is only one bus or only one type of bus.

The memory 1001 may be a volatile memory (volatile memory), for example, a random access memory (random access memory, RAM); or the memory 1001 may be a non-volatile memory (non-volatile memory), for example, a read-only memory, a flash memory (flash memory), a hard disk drive (hard disk drive, HDD), or a solid-state drive (solid-state drive, SSD); or the memory 1001 is any other medium that can be used to carry or store expected program code in a form of an instruction or a data structure and can be accessed by a computer, but is not limited thereto. The memory 1001 may be a combination of the foregoing memories.

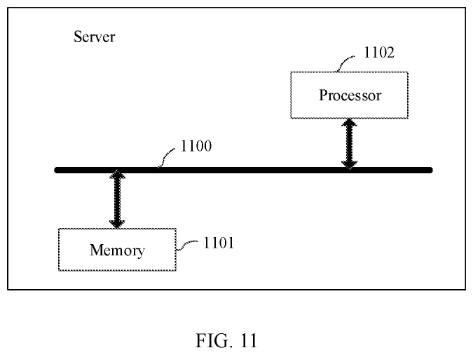

As shown in FIG. 11, an embodiment of this application provides a server, including a memory 1101 and a processor 1102. Details are as follows.

The memory 1101 is configured to store a computer program or instructions.

The processor 1102 is configured to execute the computer program or instructions in the memory, to implement any one of the methods performed by the apparatus for updating a distributed system (for example, the management server) in the foregoing embodiments.

A specific connection medium between the memory 1101 and the processor 1102 is not limited in this embodiment of this application. In this embodiment of this application, in FIG. 11, the memory 1101 and the processor 1102 are connected through a bus 1100. The bus 1100 is represented by a bold line in FIG. 11. A connection manner between other components is described merely as an example and does not constitute a limitation. The bus 1100 may be categorized as an address bus, a data bus, a control bus, or the like. For ease of representation, only one bold line is used to represent the bus in FIG. 11, but this does not mean that there is only one bus or only one type of bus.

The memory 1101 may be a volatile memory, for example, a random access memory (RAM); or the memory 1101 may be a non-volatile memory, for example, a read-only memory, a flash memory, a hard disk drive (HDD), or a solid-state drive (SSD); or the memory 1101 is any other medium that can be used to carry or store expected program code in a form of an instruction or a data structure and can be accessed by a computer, but is not limited thereto. The memory 1101 may be a combination of the foregoing memories.

Based on the same inventive concept, an embodiment of this application provides a computer-readable storage medium, where the computer-readable storage medium stores computer program instructions, and when the computer program instructions are executed by a processor, any one of the methods performed by the apparatus for updating a distributed system in the foregoing embodiments is implemented.

An embodiment of this application further provides a method for updating a distributed system. The method is applied to a controlling device included in a to-be-updated distributed system, where the to-be-updated distributed system further includes at least one controlled device, and the method includes:
receiving a download task that is sent by a management server and carries a download path for each update installation package for the to-be-updated distributed system, where the download task is sent by the management server after the management server determines the to-be-updated distributed system by comparing system-version description information of each of at least two distributed systems connected to the management server with an update installation package set, and each update installation package includes all update installation files required by a to-be-updated device in a matching to-be-updated distributed system;
downloading, from the management server, an update installation package corresponding to each download path carried in the download task; and
updating a corresponding to-be-updated device based on each downloaded update installation package.

In a possible implementation, before the receiving a download task that is sent by a management server and carries a download path for each update installation package for the to-be-updated distributed system, the method further includes:
after a system-version-description-information obtaining request sent by the management server is received, obtaining device-version description information of the controlling device and the at least one controlled device, respectively;
combining the obtained device-version description information based on hardware types to obtain the system-version description information of the to-be-updated distributed system; and
sending the system-version description information to the management server.

In a possible implementation, before the updating a corresponding to-be-updated device based on each downloaded update installation package, the method further includes:
storing all downloaded update installation packages;
adding, according to a download order of update installation packages, first storage paths for the update installation packages sequentially after a last second storage path in a first path list file stored on the controlling device to obtain a second path list file, where the first path list file includes storage paths for all running installation packages and all rollback installation packages that are stored on the controlling device before downloading is performed based on the download task;
determining a deletable installation package among all installation packages corresponding to the second path list file;
deleting a storage path for each deletable installation package from the second path list file to obtain a third path list file; and
generating latest system-installation-package version information of the to-be-updated distributed system based on the third path list file.

In a possible implementation, the determining a deletable installation package among all installation packages corresponding to the second path list file includes:
obtaining installation packages corresponding to the second path list file;
parsing the installation packages to determine a hardware type matching each of the installation packages;
determining whether each hardware type corresponds to at least three installation packages;
determining that a hardware type corresponding to at least three installation packages is a target hardware type;
obtaining an installation package corresponding to a storage path that is earliest added to the second path list file among storage paths for at least three installation packages corresponding to each target hardware type, to obtain a candidate installation package; and
obtaining a candidate installation package that does not meet a preset condition as the deletable installation package.

In a possible implementation, after the storing all downloaded update installation packages, the method further includes:
after the first path list file is obtained, backing up the first path list file; and
after the determining a deletable installation package among all installation packages corresponding to the second path list file, the method further includes:
deleting, from the backup first path list file, a storage path corresponding to each deletable installation package, to obtain a fourth path list file.

In a possible implementation, after the obtaining a third path list file, the method further includes:
replacing the first path list file with the third path list file; and
after the obtaining a fourth path list file, the method further includes:
deleting each deletable installation package from an installation package storage space.

In a possible implementation, the updating a corresponding to-be-updated device based on each downloaded update installation package includes:
determining, based on the latest system-installation-package version information, whether a to-be-updated device matching each update installation package is the controlling device;
delivering, to a corresponding controlled device, an update installation package whose matching to-be-updated device is not the controlling device, so that a controlled device receiving the update installation package is updated based on the received update installation package; and
performing an update based on an update installation package whose matching to-be-updated device is the controlling device.

In a possible implementation, after the determining, based on the latest system-installation-package version information, whether a to-be-updated device matching each update installation package is the controlling device, the method further includes:
determining whether each to-be-updated device corresponds to at least two update installation packages; and
for a to-be-updated device that corresponds to at least two update installation packages, using, as an update installation package for the corresponding to-be-updated device, an update installation package corresponding to a storage path that is last added to the second path list file among storage paths for the corresponding at least two update installation packages.

In a possible implementation, after the updating a corresponding to-be-updated device based on each downloaded update installation package, the method further includes:
when it is determined that an update for at least one to-be-updated device is abnormal or at least one device in the to-be-updated distributed system operates abnormally after an update for each to-be-updated device is completed, generating rollback system-installation-package version information of the to-be-updated distributed system based on the fourth path list file; and
performing a system-version rollback operation on the to-be-updated distributed system based on the rollback system-installation-package version information.

Another embodiment of this application further provides a method for updating a distributed system. The method is applied to a management server connected to at least two distributed systems, where the at least two distributed systems each include a controlling device and at least one controlled device, and the method includes:
comparing system-version description information of each of the at least two distributed systems with an update installation package set, to determine a to-be-updated distributed system;
determining a download task that corresponds to the to-be-updated distributed system and carries a download path for each update installation package for the to-be-updated distributed system, where each update installation package includes all update installation files required by a to-be-updated device in a matching to-be-updated distributed system; and
sending the download task to the controlling device included in the to-be-updated distributed system, so that the controlling device downloads, from the management server, an update installation package corresponding to a download path, carried in the download task, for each update installation package, and updates a corresponding to-be-updated device based on each downloaded update installation package.

In a possible implementation, before the comparing system-version description information of each of the at least two distributed systems with an update installation package set, the method further includes:
sending a system-version-description-information obtaining request to each of the at least two distributed systems, so that a distributed system receiving the system-version-description-information obtaining request obtains and returns system-version description information of the distributed system; and
receiving system-version description information sent by each of the at least two distributed systems; and
the determining a download task that corresponds to the to-be-updated distributed system and carries a download path for each update installation package includes:
determining each update installation package for the to-be-updated distributed system;
obtaining a download path for each update installation package; and
generating a download task carrying the download path for each update installation package.

Still another embodiment of this application further provides an apparatus for updating a distributed system. The apparatus is applied to a controlling device included in a to-be-updated distributed system, where the to-be-updated distributed system further includes at least one controlled device, and the apparatus includes:
a receiving module, configured to receive a download task that is sent by a management server and carries a download path for each update installation package for the to-be-updated distributed system, where the download task is sent by the management server after the management server determines the to-be-updated distributed system by comparing system-version description information of each of at least two distributed systems connected to the management server with an update installation package set, and each update installation package includes all update installation files required by a to-be-updated device in a matching to-be-updated distributed system;
a download module, configured to download, from the management server, an update installation package corresponding to each download path carried in the download task; and
an update module, configured to update a corresponding to-be-updated device based on each downloaded update installation package.

Still another embodiment of this application further provides an apparatus for updating a distributed system. The apparatus is applied to a management server connected to at least two distributed systems, where the at least two distributed systems each include a controlling device and at least one controlled device, and the apparatus includes:
a first determining module, configured to compare system-version description information of each of the at least two distributed systems with an update installation package set, to determine a to-be-updated distributed system;
a second determining module, configured to determine a download task that corresponds to the to-be-updated distributed system and carries a download path for each update installation package for the to-be-updated distributed system, where each update installation package includes all update installation files required by a to-be-updated device in a matching to-be-updated distributed system; and
a sending module, configured to send the download task to a controlling device included in the to-be-updated distributed system, so that the controlling device downloads, from the management server, an update installation package corresponding to a download path, carried in the download task, for each update installation package, and updates a corresponding to-be-updated device based on each downloaded update installation package.

A person skilled in the art should understand that the embodiments of this application may be provided as a method, a system, or a computer program product. Therefore, this application may be implemented in a form of a hardware-only embodiment, a software-only embodiment, or an embodiment with a combination of software and hardware. In addition, this application may be implemented in a form of a computer program product that is implemented on one or more computer-usable storage media (including but not limited to a disk memory, a CD-ROM, an optical memory, and the like) that include computer-usable program code.

This application is described with reference to the flowcharts and/or the block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of other programmable data processing device to generate a machine, so that the instructions executed by the computer or the processor of other programmable data processing device generate a means for implementing a specific function in one or more processes in the flowcharts and/or in one or more blocks in the block diagrams.

These computer program instructions may alternatively be stored in a computer-readable memory that can direct the computer or other programmable data processing device to operate in a specific manner, so that the instructions stored in the computer-readable memory generate an artifact that includes an instruction means. The instruction means implements a specific function in one or more processes in the flowcharts and/or in one or more blocks in the block diagrams.

These computer program instructions may alternatively be loaded onto the computer or other programmable data processing device, so that a series of operations and steps are performed on the computer or other programmable device, to generate computer-implemented processing. Therefore, the instructions executed on the computer or other programmable device provide steps for implementing a specific function in one or more processes in the flowcharts and/or in one or more blocks in the block diagrams.

Clearly, a person skilled in the art can make various modifications and variations to this application without departing from the spirit and scope of this application. This application is intended to cover these modifications and variations of this application provided that they fall within the scope of the claims of this application and equivalent technologies thereof

What is claimed is:

1. A method for updating a distributed system, applied to a controlling device comprised in a to-be-updated distributed system, wherein the to-be-updated distributed system further comprises at least one controlled device, and the method comprises:
receiving a download task sent by a management server, wherein the download task comprises a download path for an update installation package for the to-be-updated distributed system;
downloading, from the management server, a first update installation package corresponding to the download path, wherein the first update installation package comprises an update installation file for a to-be-updated device in the to-be-updated distributed system; and
updating the corresponding to-be-updated device in the to-be-updated distributed system based on the first update installation package.

2. The method according to claim 1, wherein the download task is obtained based on system-version description information of the to-be-updated distributed system.

3. The method according to claim 2, wherein that the download task is obtained based on the system-version description information of the to-be-updated distributed system comprises:
determining the to-be-updated distributed system and the download task based on the system-version description information of the to-be-upgraded distributed system and an update installation package set, wherein each update installation package in the update installation package set corresponds to a to-be-updated device in a matching distributed system.

4. The method according to claim 2, wherein before the receiving the download task sent by the management server, the method further comprises:
after a system-version-description-information obtaining request sent by the management server is received, obtaining device-version description information of the controlling device and the at least one controlled device, respectively;
combining the obtained device-version description information based on hardware types to obtain the system-version description information of the to-be-updated distributed system; and
sending the system-version description information of the to-be-updated distributed system to the management server.

5. The method according to claim 1, wherein before the updating the corresponding to-be-updated device in the to-be-updated distributed system based on the first update installation package, the method further comprises:
storing the first update installation package;
adding, according to a download order of update installation packages in the first update installation package, second storage paths for the update installation packages sequentially after a last first storage path in a first path list file stored on the controlling device to obtain a second path list file, wherein the first path list file comprises storage paths for all running installation packages and all rollback installation packages that are stored on the controlling device before downloading is performed based on the download task;
determining a deletable installation package among all installation packages corresponding to the second path list file;
deleting a storage path for each deletable installation package from the second path list file to obtain a third path list file; and
generating latest system-installation-package version information of the to-be-updated distributed system based on the third path list file.

6. The method according to claim 5, wherein the determining the deletable installation package among all installation packages corresponding to the second path list file comprises:
obtaining installation packages corresponding to the second path list file;
parsing the installation packages to determine a hardware type matching each of the installation packages;
determining whether each hardware type corresponds to at least three installation packages;
determining that a hardware type corresponding to at least three installation packages is a target hardware type;
obtaining an installation package corresponding to a storage path that is earliest added to the second path list file among storage paths for the at least three installation packages corresponding to each target hardware type, to obtain a candidate installation package; and
obtaining a candidate installation package that does not meet a preset condition as the deletable installation package.

7. The method according to claim 5, wherein after all downloaded update installation packages are stored, the method further comprises:
after the first path list file is obtained, backing up the first path list file; and
after the determining the deletable installation package among all installation packages corresponding to the second path list file, the method further comprises:
deleting, from the backup first path list file, a storage path corresponding to each deletable installation package, to obtain a fourth path list file.

8. The method according to claim 7, wherein after the obtaining the third path list file, the method further comprises:
replacing the first path list file with the third path list file; and
after the obtaining the fourth path list file, the method further comprises:
deleting each deletable installation package from an installation package storage space.

9. The method according to claim 5, wherein the updating the corresponding to-be-updated device in the to-be-updated distributed system based on the first update installation package comprises:
determining, based on the latest system-installation-package version information, whether the to-be-updated device matching the first update installation package is the controlling device;
delivering, to a corresponding controlled device, a second update installation package that is in the first update installation package and matches a to-be-updated device from the at least one controlled device, so that the controlled device receiving the second update installation package is updated based on the second update installation package; and
performing an update based on a third update installation package that is in the first update installation package and matches a to-be-updated device being the controlling device.

10. The method according to claim 9, wherein after the determining, based on the latest system-installation-package version information, whether the to-be-updated device matching the first update installation package is the controlling device, the method further comprises:
determining whether the to-be-updated device corresponds to at least two update installation packages; and
for a to-be-updated device that corresponds to at least two update installation packages, using, as an update installation package for the corresponding to-be-updated device, an update installation package corresponding to a storage path that is last added to the second path list file among storage paths for the corresponding at least two update installation packages.

11. The method according to claim 7, wherein after the updating the corresponding to-be-updated device in the to-be-updated distributed system based on the downloaded first update installation package, the method further comprises:
when it is determined that an update for at least one to-be-updated device is abnormal or at least one device in the to-be-updated distributed system operates abnormally after an update for each to-be-updated device is completed, generating rollback system-installation-package version information of the to-be-updated distributed system based on the fourth path list file; and
performing a system-version rollback operation on the to-be-updated distributed system based on the rollback system-installation-package version information.

12. A method for updating a distributed system, applied to a management server connected to at least two distributed systems, wherein the at least two distributed systems comprise a controlling device and at least one controlled device, respectively, and the method comprises:
sending a download task to a controlling device comprised in a to-be-updated distributed system, wherein the download task comprises a download path for an update installation package for the to-be-updated distributed system, and the download task is obtained based on system-version description information of the to-be-updated distributed system, so that the controlling device downloads a first update installation package corresponding to the download path from the management server, and updates a corresponding to-be-updated device in the to-be-updated distributed system based on the first update installation package.

13. The method according to claim 12, wherein that the download task is obtained based on the system-version description information of the to-be-updated distributed system comprises:
determining the to-be-updated distributed system and the download task based on the system-version description information of the to-be-updated distributed system and an update installation package set, wherein each update installation package in the update installation package set corresponds to a to-be-updated device in a matching distributed system.

14. The method according to claim 13, wherein the determining the to-be-updated distributed system and the download task based on the system-version description information of the to-be-updated distributed system and the update installation package set comprises:
sending a system-version-description-information obtaining request to the at least two distributed systems, respectively, so that a distributed system receiving the system-version-description-information obtaining request obtains and returns system-version description information of the distributed system;
receiving system-version description information sent by the at least two distributed systems, respectively;
determining each update installation package for the to-be-updated distributed system;
obtaining a download path for each update installation package; and
generating a download task carrying the download path for each update installation package.

15. A network device, wherein the network device comprises a processor and a memory;
the memory is configured to store a computer program or instructions; and
the processor is configured to execute the computer program or instructions in the memory, so that the method according to claim 1 is performed.
